(19) United States
(12) Patent Application Publication
(10) Pub. No.: US 2007/0031292 A1
(43) Pub. Date: Feb. 8, 2007

(54) Chemical sensors featuring dual-sensing motifs

(75) Inventors: Karl S. Booksh, Phoenix, AZ (US); Anna M. Prakash, Chandler, AZ (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Arizona Board of Rrgents, acting for an on behalf of Azona State University, Tempe, AZ (US)

(21) Appl. No.: 10/576,578

(22) PCT Filed: Oct. 22, 2004
(86) PCT No.: PCT/US04/35297

§ 371 Date: Apr. 20, 2006

Related U.S. Application Data
(60) Provisional application No. 60/513,301, filed on Oct. 22, 2003.

(51) Int. Cl. G01N 21/64

(52) U.S. Cl. 422/82.08

(57) ABSTRACT

Apparatus and methods featuring a sensor (10) having dual-sensing motifs. The sensor (10) includes an entrant medium (12), a thin metal film layer (14), sensing elements (16), and a fluorescent molecule (18) associated with the sensing elements (16). A target molecule (20) is captured by the sensing elements (16), and Surface Plasmon Resonance (SRP) and fluorescent detection are employed. The apparatus and methods were tested for the detection of Pinacolyl methylphosphanate (PMP), a simulant for nerve agent Soman.

### STATEMENT OF RELATED APPLICATION

This application claims the benefit of U.S. Provisional Patent Application Ser. No. 60/513,301 filed on Oct. 22, 2003.

### BACKGROUND OF THE INVENTION

1. Field of the Invention

This invention relates in general to optical sensors and more particularly to an optical sensor that utilizes the phenomena of surface plasmon resonance and fluorescence to spectroscopically characterize the presence of a target molecule.

2. Description of the Related Art

Surface plasmon resonance (SPR) is a phenomenon used in many analytical applications in metallurgy, microscopy, and chemical and biochemical sensing. Along with optical techniques such as ellipsometry, multiple internal reflection spectroscopy, and differential reflectivity, SPR is one of the most sensitive techniques to surface and interface effects. This inherent property makes SPR well suited for nondestructive studies of surfaces, interfaces, and very thin layers. The SPR phenomenon has been known for decades and the theory is fairly well developed. Simply stated, a surface plasmon is an oscillation of free electrons that propagates along the surface of a conductor. The phenomenon of surface plasmon resonance occurs under total internal reflection conditions at the boundary between substances of different refractive indices, such as glass and water solutions. When an incident light beam is reflected internally within the first medium, its electromagnetic field produces an evanescent wave that crosses a short distance (in the order of nanometers) beyond the interface with the second medium. If a thin metal film is inserted at the interface between the two media, surface plasmon resonance occurs when the free electron clouds in the metal layer (the plasmons) absorb energy from the evanescent wave and cause a measurable drop in the intensity of the reflected light at a particular angle of incidence that depends on the refractive index of the second medium.

Typically, the conductor used for SPR spectrometry is a thin film of metal such as silver or gold; however, surface plasmons have also been excited on semiconductors. The conventional method of exciting surface plasmons is to couple the transverse-magnetic (TM) polarized energy contained in an evanescent field to the plasmon mode on a metal film. The amount of coupling, and thus the intensity of the plasmon, is determined by the incident angle of the light beam and is directly affected by the refractive indices of the materials on both sides of the metal film. By including the sample material to be measured as a layer on one side of the metallic film, changes in the refractive index of the sample material can be monitored by measuring changes in the surface plasmon coupling efficiency in the evanescent field. When changes occur in the refractive index of the sample material, the propagation of the evanescent wave and the angle of incidence producing resonance are affected. Therefore, by monitoring the angle of incidence at a given wavelength and identifying changes in the angle that causes resonance, corresponding changes in the refractive index and related properties of the material can be readily detected.

As those skilled in the field readily understand, total reflection can only occur above a particular critical incidence angle if the refractive index of the incident or entrant medium (typically a prism or grating) is greater than that of the emerging medium. In practice, total reflection is observed only for incidence angles within a range narrower than from the critical angle to 90 degrees because of the physical limitations inherent with the testing apparatus. Similarly, for systems operating with variable wavelengths and a given incidence angle, total reflection is also observed only for a corresponding range of wavelengths. This range of incidence angles (or wavelengths) is referred to as the “observable range” for the purpose of this disclosure. Moreover, a metal film with a very small refractive index (as small as possible) and a very large extinction coefficient (as large as possible) is required to support plasmon resonance. Accordingly, gold and silver are appropriate materials for the thin metal films used in visible-light SPR; in addition, they are very desirable because of their mechanical and chemical resistance.

Thus, once materials are selected for the prism, metal film and emerging medium that satisfy the described conditions for total reflection and plasmon resonance, the reflection of a monochromatic incident beam becomes a function of its angle of incidence and of the metal's refractive index, extinction coefficient, and thickness. The thickness of the film is therefore selected such that it produces observable plasmon resonance when the monochromatic light is incident at an angle within the observable range.

The classical embodiments of SPR devices are the Kretschmann and Otto prism or grating arrangements, which consist of a prism with a high refractive index n (in the 1.4-1.7 range) coated on one face with a thin film of metal. The Otto device also includes a very thin air gap between the face of the prism and the metal film. In fact, the gap between the prism (or grating) and the metal layer, which is in the order of nanometers, could be of a material other than air, even metal, so long as compatible with the production of observable plasmon resonance in the metal film when the monochromatic light is incident at an angle within the observable range.

The idea of measuring SPR-related phenomena in high-throughput sensing applications has become the focus of much research. Indeed, the development of “functionalized” or “smart” sensors capable of detecting the presence of a desired target molecule continues to be explored using a variety of chemical techniques. Of these techniques, molecularly imprinted polymers (MIPs) have gained wide spread interest in recent years in the design and development of smart sensors (see Takeuchi, T., Fukuma, D., and Matsui, J., Anal. Chem., 71, 285-290, 1999; Jenkins, A. L., Yin, R., and Jensen, J. L., Analyst, 126, 798-802, 2001; and Sergeyeva, T. A., Piletsky, S. A., Brovko, A. A., Slinchenko, E. A., Sergeeva, L. M., and El'skaya, A. V., Anal. Chim. Acta., 392, 105, 1999).

MIPs are capable of changing their optical characteristics in a predictable way in the presence of an imprint molecule and are less prone to suffer from changes in pH, temperature, and trace of impurities that can easily contaminate the sensing surface or substrate. Moreover, MIPs are tailor-made recognition elements that introduce specific recognition characteristics and could provide a promising alternative to biomolecule based recognition elements such as antibody fragments.

The need for the rapid and reliable detection of dangerous chemicals, such as nerve agents, has been present in military contexts at least since the first world war. While international conventions have lessened the chance that such agents will be used by governments, this need has become more acute due to a recently heightened awareness of terrorist interest in nerve agent acquisition and use. Typical analytical methods currently used for the detection of nerve agents include ion mobility spectrometry or IMS (see Brietich, N. R.; Waters, M. J.; Tracy, M. F., Worldwide Chemical Detection Equipment Handbook, Chemical and Biological Defense Information Analysis Center: Aberdeen, M D, 1995), HPLC-GC/MS (see D'agostino, P. A., Provost, L. R., and Brooks, P. W., J Chromatog, 541, 121-130, 1991; Black, R. M., Clarke, R. J., and Reid, M. J., J. Chromatog., 662, 301-321, 1994; and Santesson, J. FOA Briefing on Chemical Weapons, Edgewood Arsenal, 1974.), SAW (see Nieuwenhuizen, M. S. and Harteveld, J. L. N., Talanta, 41, 461-472, 1994; and Kepley, L. J., Crooks, R. M., and Ricco, A., J. Anal. Chem., 64, 3191-3193, 1992), luminescence spectroscopy (see Jenkins, A. L., Uy., O. M., and Murray, G. M., Anal. Chem., 71, 373-378, 1999), and enzyme based chemistry (see Trettnak, W., Reininger, Zinterl, E., and Wolfbeis, O. S., Sens. Actuators B, 11, 87-93, 1993).

However, all of the detection methods above have drawbacks. “Matrix effects,” such as humidity, temperature, and composition of an air sample can easily influence the IMS detector response. SAW-based sensors, although fast, respond to all organophosphates (i.e., lack specificity) and are sometimes irreversible. HPLC-GC/MS requires extensive pre-analysis procedures. The enzyme chemistry used in field analysis today can take up to 20-30 minutes to provide results and is not reusable. Luminescence-based fiber optic sensors for nerve agent detection can take about 15 minutes to provide results & have heavy optical components.

Engineering sensor surfaces at a molecular level can lead to well-defined functionality, with better macroscopic properties than those obtained by conventional methods of surface modifications. The conventional casting methods of creating functionalized surfaces are based on dip coating of a preformed polymer (see Tsubokawa, N., Hosoya, M., Yanadori, K., and Sone, Y., J. Macromol. Sci. Chem., A27, 445, 1990; Zajac, R and Chakrabarti, A., Phys. Rev. E, 52, 6536, 1995) or by selective adsorption of a diblock copolymer (see Hadziioannou, G., Patel, S., Granick, S., and Tirrell, M., J. Am. Chem. Soc., 108, 2869-2876, 1986; Spatz, J. P., Möller, M., Noeske, M., Behm, R. J., and Pietralla, M., Macromolecules, 30, 3874-3880, 1997). However, stearic and entropic forces hamper the growth of nano-scale layers from solution once the surface is significantly covered with an initial layer of a polymer layer. Also, the conventional methods generally lead to non-uniform thin polymer films, which could affect the functionality of the surface and lead to poor surface coverage due to the formation of so called islands and mushrooms on the surface. Other well-known methods such as polyelectrolyte deposition, plasma deposition, and polymerization with Langmuir-Blodgett (LB) film suffer from the same disadvantages.

The direct initiation of a polymer chain from the surface has been explored as an alternative method for creating functionalized surfaces by chemically grafted thermal initiators to the surface of a silicon wafer or a gold-coated glass surface (see de Boer, B., Simon, H. K., Werts, M. P. L., van der Vegte, E. W., and Hadziioannou, G., Macromolecules, 33, 349-356, 2000; Tsubokawa, N. and Hayashi, S., J. Macromol. Sci. Chem., A32, 525, 1995; Pucker, O. and RÜhe, J., Macromolecules, 31, 602-613, 1998; Wittmer, J. P., Cates, M. E., Johner, A., and Turner, M. S., Europhys. Lett., 33, 397, 1996.; and Szleifer, O. and Carignano, A., Adv. Chem. Phys., 94, 165, 1996). With most of the polymer-based sensors produced by dip coating methods, reproducibility due to leaching of the imprint molecules trapped in the inner core layers over time is a serious concern. Additionally, in SPR-based detection methods, molecular imprinting by dip coating will create very thick polymer layer affecting the sensitivity of the SPR sensor because the effective distance of surface plasmon penetration is only few hundred nanometers. Therefore, creating monolayers of molecularly imprinted functional polymers close to the sensing surface will allow greater access of the target molecules to the sensing area and improve reproducibility of the sensor. Nonetheless, the selectivity and sensitivity of SPR-based sensors continues to need refinement.

In view of the above, a need still exists for a new and useful sensor that overcomes some of the problems and shortcomings of the art. Any detection system used under such conditions should be fast, accurate, mobile, and fiber-optic based to provide reliable results.

### SUMMARY OF THE INVENTION

The invention relates in general to a new sensor apparatus, system, and method that utilizes a dual sensing motif involving the phenomenon of surface plasmon resonance and fluorescence to spectroscopically characterize the presence of a target molecule or ion.

In one embodiment, a monolayer of polymerization initiator is covalently attached to the surface of an SPR-fiber optic surface. An imprint molecule (i.e., a target molecule) is present in a polymerizable metal monomer complex where it occupies a well-co-coordinated site within the complex. Cross-linking the vinyl groups present on the complex to the growing monomer or polymer chain on the surface of the SPR probe creates a very thin layer of molecularly imprinted metal-polymer-matrix suitable for SPR-based signal sensing and fluorescent signal generating.

After extraction of the target molecules, complimentary cavities remain in the polymer, which will be available to detect any new target molecule in solution. The inclusion and exclusion of the target molecule into or out of the polymer layers creates a change in the refractive index of the sensing substrate and is transduced by the evanescent field created by the surface plasmon resonance. This effect is measured in real time sensing.

The performance of the SPR sensor off-line or on-line is confirmed and/or optimized by using a fluorescent molecule, such as lanthanide signal transducers embedded within a nano-polymer layer. The presence of a fluorescent molecule, such as a lanthanide series element, invokes a specific spectral signature during the binding and removal of the target molecule. This spectral signature is used to confirm and/or optimize the performance of the SPR sensor in terms of selectivity and sensitivity. Therefore, a novel and improved sensor, system, and method featuring dual sensing motifs is provided.

In another embodiment, the presence of a lanthanide signal transducer cross-linked into a growing polymer chain enables the optimization of the SPR sensor to selectively respond to the binding or removal of a target molecule of interest. This increases the sensitivity and selectivity of the sensor for the real-time detection of the target molecule. SPR signal and luminescent signal from the fiber may be isolated by using two different excitation/emission wavelength ranges.

Various other purposes and advantages of the invention will become clear from its description in the specification that follows and from the novel features particularly pointed out in the appended claims. Therefore, to the accomplishment of the objectives described above, this invention consists of the features hereinafter illustrated in the drawings, fully described in the detailed description of the preferred embodiment and particularly pointed out in the claims. However, such drawings and description disclose but one of the various ways in which the invention may be practiced.

### BRIEF DESCRIPTION OF THE DRAWINGS

FIG. 1 illustrates a fiber-optic surface plasma resonance sensor with a molecularly imprinted lanthanide-based test bed as an example.

FIG. 2A schematically illustrates the protocol for molecular imprinting of a target molecule (MP) on a SPR probe for bulk polymerization from solution.

FIG. 2B schematically illustrates the protocol used for molecular imprinting of a target molecule (PMP) on a SPR probe for surface initiated polymerization.

FIG. 3 displays the surface-initiated polystyrene growth monitored by ATR-FTIR; the C═C and C—H stretch vibration peaks typical of polystyrene increase over the period of time shown.

FIG. 4 displays PMP binding on a polystyrene surface studied by ATR-FTIR.

FIG. 5 depicts SPR responses to 100 ppb PMP in direct assay; the top lines are the MIP-SPR probe; the bottom lines are the control-SPR probe.

FIG. 6 schematically depicts another embodiment of the invention.

### DESCRIPTION OF THE PREFERRED EMBODIMENTS

In general, the invention involves a sensor that combines the phenomena of SPR and fluorescence in one sensing device. Thus, the sensor of the invention may be used to confirm and/or optimize measurements and methods for detecting a target molecule for greater reliability that is especially useful during live field-testing applications.

For the purposes of this disclosure, the terms “imprint molecule” or “template molecule” signify a molecule or molecules used to sensitize the binding elements of the sensor of the invention to a particular target molecule or molecules. Moreover, the term “target molecule” includes an ion or analyte. Thus, it should be understood that a fluorescent molecule of the invention is in addition to and separate from the target molecule, ion or analyte with which the invention is used.

Molecular imprinting is a well-explored subject. Yet, in the case of surface plasmon resonance based fiber optic sensors, it is often a challenge to get a very thin (50 nm) layer of structured, functional, and molecularly imprinted polymer layer on the surface of the metal-coated fiber.

Currently, the majority of papers on MIPs describe polymers synthesized by radical polymerization of functional and cross-linking monomers having vinyl or acrylic groups and using non-covalent interactions (see Haupt K., Analyst, 126, 747-756, 2001). Most of these MIP-based sensors are produced by dip coating methods. In designing our sensor, we have used two different approaches. One approach is molecular imprinting from bulk polymerization solution, where the imprint molecule Pinacolyl Methyl Phosphonate (“PMP,” a simulate of the nerve agent Soman) is premixed into a solution of monomers, initiators and cross-linkers and under suitable conditions imprinted on the surface of the SPR fiber directly from a polymerization solution.

The other approach is to use surface initiation, where, the polymerization initiator is first covalently linked to the surface of the SPR fiber to initiate polymer growth from the surface of the fiber. The imprint molecule PMP is present in a polymerizable metal complex such as [Europium(vinyl benzoate)ₙPMP], where it occupies a well-co-coordinated site within the complex. Cross-linking the vinyl groups present on the complex to the growing polymer chain on the surface of the SPR probe could create a very thin layer of MIP suitable for SPR signal sensing. After extraction of the template molecules, complimentary cavities remain in the polymer, which will be available to detect any new PMP molecule in solution. Thus, the inclusion & exclusion of the target molecule (e.g., PMP) into/out of the cavities left in the polymer layers creates a change in the refractive index of the sensing material and is transduced by the evanescent field created by the surface plasma resonance. Moreover, the inclusion of a fluorescent molecule or complex (typically as part of a polymer matrix) allows the performance of the sensor to be optimized by using, for example, luminescent lanthanide signal transducers embedded in the polymer layer as an optimizing test bed for the MIP-SPR sensor.

### EXAMPLE

The growth and the testing of molecularly imprinted polymers on the surface of a fiber-optic based SPR sensor tailored for the detection of nerve agent PMP [CH₃POOHOCHCH₃C(CH₃)₃] in solution is accomplished as follows.

1.1 Background

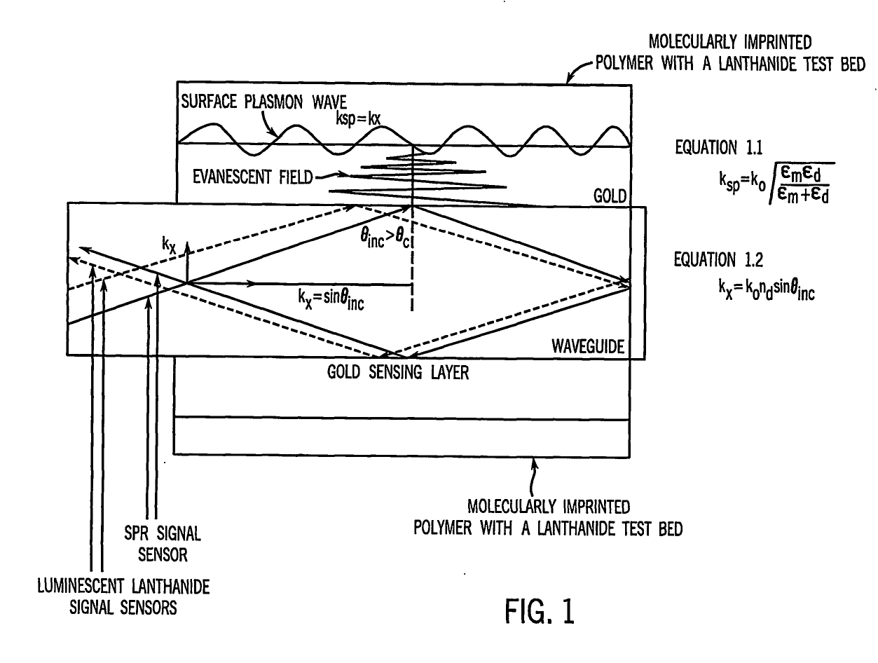

The evanescent wave from the light in total internal reflection through the fiber optic can excite a standing charge on the metal film (in this case gold) surface of the SPR sensor. The localized fluctuations of electron density on the surface of the metal are known as surface plasmon. The surface plasmon (SP) wave is modulated from the dielectric constant of the thin gold film and the dielectric constant of the molecules adsorbed on the surface and within 100 nm of the surface as shown in the FIG. 1. The light at a fixed wavelength and fixed angle will enter in resonance with the surface plasmon and the photon will be absorbed. This will be seen by a minimum in the reflection spectra. The position of the minima is indicative of the refractive index of the material on the surface.

2.1 Chemicals Used

Unless specified, all chemicals were used as purchased without prior purification and freshly prepared as required. Pinacolyl methylphosphonate (PMP), styrene, methacrylic acid (MAA), ethylene glycol dimethacrylate (EDMA), vinyl benzoate, 11-mercaptoundecanol, 4,4′-Azobis(4-cyano-valeric acid), 2,2′-Azobisisobutyronitrile (AIBN), epichlorhydrin, ethanolamine, N-hydroxysuccinimide (NHS), N-(3-dimethylaminopropyl)-N′-ethyl-carbodiimide hydrochloride (EDC) were all purchased from Aldrich, and divinyl benzene was purchased from Fluka

2.2 Attenuated Total Reflectance Fourier Transformed IR Spectroscopy (ATR-FTIR)

Brunker Optics IFS 66 v/S Vacuum FTIR, with a resolution of 4 cm⁻¹ and number of scans is 1024. The Harrick Scientific GATR™ grazing angle infrared ATR accessory used in this study uses 65° grazing angle ATR to study adsorbed species and monolayers on semiconductor and metallic substrates such as gold. The GATR™ is optimized for high sensitivity to these types of samples & gives repeatable measurements. Its specially designed pressure applicator is optimized for delivering good contact between the sample and the Ge ATR crystal. The ATR-IR provides at least an order of magnitude increase in sensitivity relative to grazing angle methods hence it was used in this study.

2.3 SPR Equipment

The light source is a white LED with a maximum emission at 640 nm, and the spectrometer is a Jobin Yvon SPEX 270M housing with an 1800 grooves/mm grating blazed at 450-850 nm (Jobin Yvon Inc). The detector is a CCD camera from Andor technologies model DU420-BR-DD. The region of interest on the CCD is vertically binned to across a 40 pixels stripe. The acquired signal by the Andor Basic software is converted to a text file and processed with Matlab 6.5. The fiber optic jumper was made with a 200-micron diameter fused silica fiber with a polyimide coating (Polymicro). The fiber optic probes are made with 400-micron diameter silica fibers. The Cr and Au layers are deposited with a Cressington 208HR sputter coater.

2.4 Preparation of Fiber-Optic Surface Plasma Resonance Probes

The development of fiber-optic based SPR sensor in our research lab is well documented (see Obando, L. A. and Booksh, K. S., Anal. Chem., 71, 5116-5122, 1999). The fiber is a 400-micron silica core with a TECS cladding and a TEFZEL buffer (Thor Labs) with a numerical aperture of 0.39. The tip of the optical fiber is polished flat with lapping films (Thor Labs). A mirror is affixed onto the tip of the fiber optic probe by sputtering, first a layer of Cr (5 nm) followed by a layer of Au (50 nm). The fiber is then mounted in connector polished to ensure good optical coupling with the fiber optic jumper. Finally, approximately 1 cm of cladding near the tip of the silica fiber is removed by rubbing the cladding with a wiper soaked in acetone and then Cr and Au are sputter coated in the sensing area. The fibers are divided for use with either surface initiated polymerization or bulk polymerization as described below.

2.4.1. Preparing Fiber-Optic SPR Probes for Bulk polymerization from solution

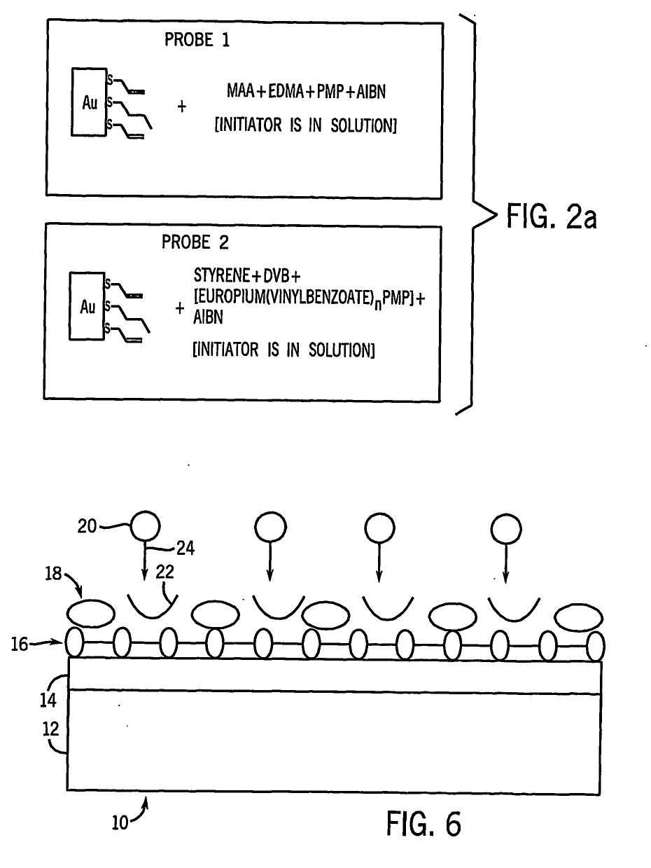

The gold coated surface of the SPR fiber-optic probes from section 2.4. were immersed in an ethanol/water (4:1, v/v) solution containing ally mercaptane (3.0 mM) and 1-butanethiol (1.5 mM) for 24 hrs. This process covers the gold surface of the SPR probe with short carbon chain molecules containing polymerizable vinyl terminal groups as shown in FIG. 2A. The modified SPR probes were thoroughly rinsed with ethanol and dried with N₂.

2.4.2. Preparing Fiber-Optic SPR Probes for Surface Initiated Polymerization

In order to create a covalently linked self-assembled monolayer of a polymerization initiator, [4,4′-Azobis(4-cyano-valeric acid)], on the gold-coated surface of the SPR fiber as shown in FIG. 2B, the probes from section 2.4, were processed in the following manner. The fiber was immersed overnight with 0.005M 11-mercaptoundecanol, washed by ethanol and dried in a stream of N₂. The 11-mercaptoundecanol on the gold was then reacted with epichlorhydrin in a mixture of diglyme and NaOH for 4 hours to give a reactive epoxide terminal. The epoxide was reacted with ethanolamine. The amine terminal was reacted with 4,4′-Azobis(4-cyano-valeric acid) in the presence of EDC/NHS mixture. All reactions were reproduced on gold-coated glass surface and followed by ATR-FTIR to optimize reaction conditions, to ensure completion of the reactions and to confirm the binding of the polymerization initiator to the surface of the SPR fiber.

2.5 Complex Preparation

[Europium(vinyl benzoate)nPMP] complex was synthesized by mixing one mole of europium, one mole of PMP and n moles of vinyl benzoate as coordinating ligands and adjusting the pH suitable for complexation (see De Boer, B., Simon, H. K., Werts, M. P. L.m, Van der Vegte, E. W., and Hadziioannou, G., Macromolecules, 33, 349-356, 2000; Tsubokawa, N. and Hayashi, S., J. Macromol. Sci. Chem., A32, 525, 1995; and Pucker, O. and RÜhe, J., Macromolecules, 31, 602-613, 1998). 3-7 moles of vinyl benzoate were used to as ligating molecules to accommodate the 9 coordination of the Eu3+. A number of fluorescent ligands would be suitable for cross-linking to the SPR probe. A blank complex without PMP was also synthesized in a similar manner.

2.6 Preparation of Molecularly Imprinted SPR Fiber Optic Probes

Two different polymers were used in this study. One is methacrylic acid and ethylene glycol dimethacrylate based polymer. The other is styrene and divinylbenzene based polymer. They were polymerized on the surface of gold-coated SPR fibers using thermally induced free radical based polymerization. The following sections explain the fiber surface modification in the case of surface initiated polymerization and in the case of bulk polymerization from solution.

2.6.1 Preparation of Molecularly Imprinted SPR Probes from Bulk Polymerization

For methacrylic acid (MAA) based polymerization of MIP from solution, a solution was prepared with 3 mol % of PMP as template molecule, 16 mol % of MAA as a functional monomer, 81 mol % of EDMA as a cross-linking monomer and 10 mg of AIBN as an initiator, dissolved in 18 ml of acetonitrile as a porogenic solvent. The control polymer solution was prepared in a similar fashion, but without introduction of the template molecule (PMP). The two solutions (with and without PMP) were sonicated under N₂ for 30 minutes. The modified fibers from section 2.4.1 were directly dipped into to these solutions and maintained at about 60 C for 1-2 hrs. The polymers thus created on the SPR probes were swelled in methanol to remove un-reacted monomer and the imprinted molecule. Additionally the imprint molecule on the SPR probe was extracted in a batch mode, using 0.25% nitric acid in methanol/water (1:1, v/v) (3×10 min and room temperature). FIG. 2A, Probe 1, describes the surface modification.

For Styrene based polymerization of MIP from solution, a solution was prepared by adding 3-5 mol % of complex synthesized in section 2.5 (with imprint molecule), 10 mg of 4,4′-Azobis(4-cyano-valeric acid) as an initiator, 90-95 mol % styrene as a functional monomer & 1-2 mol % divinyl benzene as a cross-linker. Jenkins et al. demonstrated that lower levels of cross-linking monomer allow better accessibility to the site in real time monitoring (see Nieuwenhuizen, M. S. and Harteveld, J. L. N., Talanta, 41, 461-472, 1994; Kepley, L. J., Crooks, R. M., and Ricco, A., J. Anal. Chem., 64, 3191-3193, 1992). The control polymer solution was formulated in a similar fashion, but using 3-5 mol % complex synthesized without the imprint molecule (section 2.5). The two solutions were sonicated under N₂ for 30 minutes. The modified fibers from section 2.4.1 were directly dipped into to these solutions and maintained at about 60 C for 1-2 hrs. The extraction procedures were carried out as described above. FIG. 2A, Probe 2, describes the surface modification in detail.

2.6.2 Preparation of Molecularly Imprinted SPR Probes from Surface Initiation

For surface initiated polymerization, the initiator, 4,4′-azobis(4-cyano-valeric acid), was covalently attached to the surface of the fiber as described in section 2.4.2. Methacrylic acid & styrene-based solutions were prepared as described above in section 2.6.1 but without the inclusion of the initiator in these solutions. This allows polymerization to initiate from the surface of the SPR fiber. The two solutions were sonicated under N₂ for 30 minutes. The SPR probes reported in section 2.4.2, with the initiator attached to the fiber were allowed to react in these solutions and maintained at about 60 C for a period of about 1-2 hrs. Under these conditions, the initiator attached to the surface of the fiber dissociates forming free radicals, thus initiating a well-controlled polymerization at the surface of the SPR fiber and also cross-linking the complex to the surface of the sensor. Control probes were made without the template molecules. The extraction procedures were carried out as described above in section 2.6.1. FIG. 2B, Probe 3 describes surface modification of the SPR probe with methacrylate-based system and FIG. 2B, Probe 4 describes surface modification of the SPR probe with styrene-based system.

3.1. ATR-FTIR Study

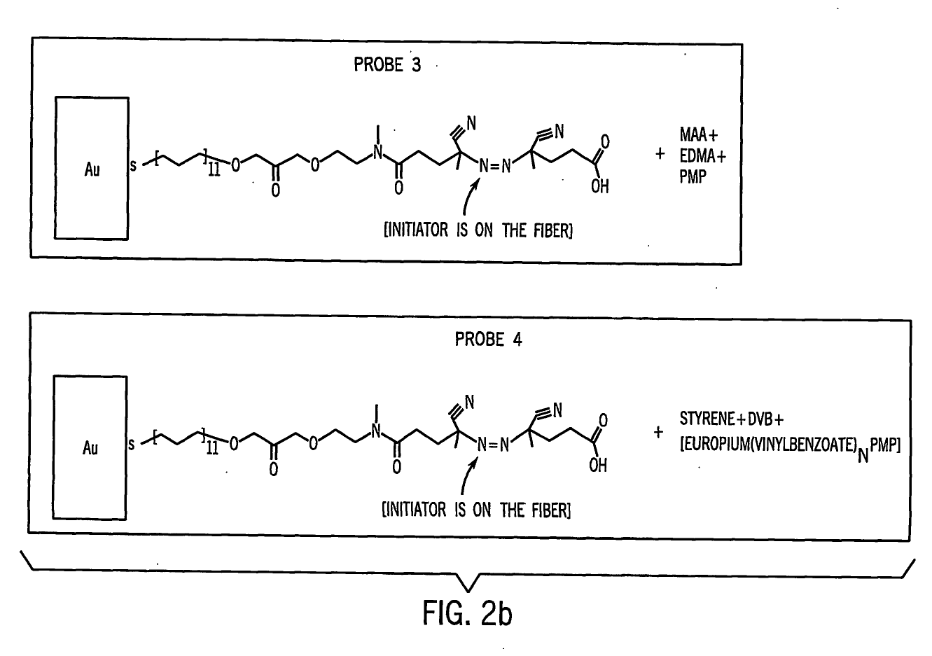

The reactions detailed in section 2.6 were reproduced on Au-coated glass surfaces for ATR-IR study. FIG. 3 shows the initial formation of a monolayer of styrene on the surface in less than 15 minutes. Two other spectra, collected after 4 hours and 6 hours show typical IR peaks growing in the C—H and C═C stretch vibrations as can be seen in the spectrum of reference polystyrene (top). The ATR-IR was studied when the sensing elements [Europium (vinyl benzoate)ₙPMP] or the imprint molecule (PIMP), was added to the polymer mixture and allowed to cross-link or adsorb on the surface of the growing polymer network on the surface.

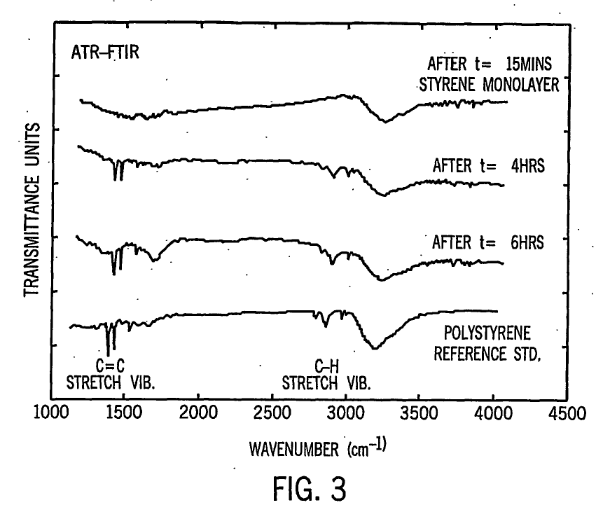

In the case of the PMP immobilized directly on the polymer, the reaction can be easily followed with ATR-IR as shown in FIG. 4. The IR peaks due to P═O, P—O—C stretch are unique and easy to identify during the inclusion and the exclusion of the PMP molecule from the surface of the polymer, when it is directly immobilized on the surface. However, in the case of molecular imprinting with [Europium(vinyl benzoate)ₙPMP] complex, due to the large size of the lanthanide ion & the monomers compared to the PMP molecule, IR methods will not be sufficient for optimization. In this case, changes in the luminescent signal of the europium ion due to the changes in its electronic environment are a better choice as a signal transducer for off-line optimization of the sensor. The changes in the electronic environment of the lanthanide with and without the PMP molecule can be very specific as shown by Jenkins et al. (see De Boer, B., Simon, H. K., Werts, M. P. L.m, Van der Vegte, E. W., and Hadziioannou, G., Macromolecules, 33, 349-356, 2000; Tsubokawa, N. and Hayashi, S., J. Macromol. Sci. Chem., A32, 525, 1995; and Pucker, O. and RÜhe, J., Macromolecules, 31, 602-613, 1998). A number of lanthanide complexes are currently under study for this purpose for use with SPR probes and are discussed in our next publication in detail (Prakash, A.; Kim, Y. C.; Banerji, S.; Booksh, K. S., In Preparation, 2003).

3.2. SPR Study

In order to investigate the use of MIP-based SPR probes to determine PMP, the binding phenomena of molecularly imprinted materials on the modified surfaces were studied by using fiber-optic SPR spectroscopy. As described in section 2-6, two different approaches, one from bulk polymerization and the other from surface initiated polymerizations were used to prepare the MIP. The change in the SPR coupling wavelength caused by binding of the styrene-based polymer material from bulk polymerization was studied. The change in SPR coupling wavelength increases with increase in the polymerization time and indicated that the styrene-based polymer material was polymerized on the SPR probe. A similar, time-dependent, but large positive change in SPR coupling wavelength was observed during styrene-based polymerization with surface initiated polymerization. On the other hand, when the MAA-based polymerization was monitored with fiber-optic SPR spectroscopy, the SPR spectra were not observed due to the cut off in the range of the refractive index covered by the current SPR sensor. The refractive index of the polymer materials obtained by a.KRUSS OPTRONIC refractometer are as follows: Styrene-based polymer material, RI=1.3348; MAA-based polymer material, RI=1.4445. The current fiber-optic SPR sensor covers a refractive index range of 1.3298-1.4006.

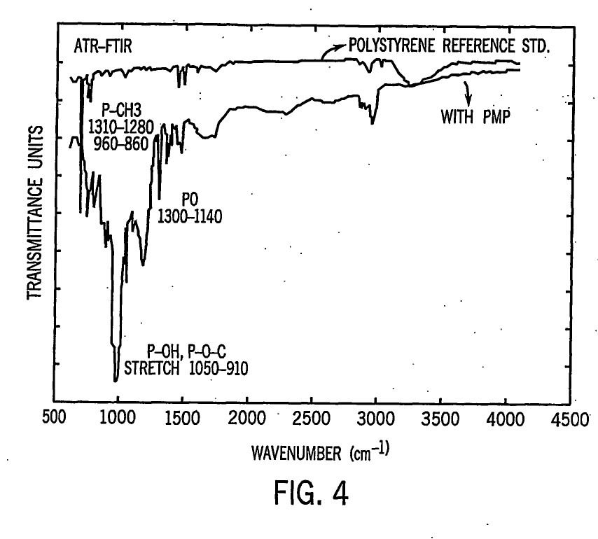

FIG. 5. shows the kinetics of adsorption of PMP on the four different SPR probes upon exposure to PMP solutions (100 ppb in methanol/water (1:1, v/v)) and subsequent solvent (methanol/water (1:1, v/v)) in a batch mode. Each graph has two signals: one is from imprinted polymer-coated SPR probe; the other one is from unimprinted polymer-coated SPR probe as a control. Additionally each graph has three regions: first and third regions indicate the SPR responses of the solvent; second region indicates the SPR coupling wavelength changes in 100 ppb PMP sample. The arrows indicate exchange point of samples. Unlike conventional flow system based SPR sensors, in the fiber optic based SPR systems, rapid negative/positive changes in SPR coupling wavelength is observed when exchanging MIP and control SPR probes to PMP/subsequent solvent solutions. This is due to the sensitivity of our SPR sensors to very little differences in the concentration between the solvent of PMP sample and the assay running solvent. The rapid response is followed by slower increase/decrease as the PMP bound to the MIP polymers on the SPR probes.

The difference in the SPR signals during PMP binding on the probes made by bulk polymerization and surface initiated polymerization was investigated with probes 1 and 2 vs. probes 3 and 4. The density of MIP recognition sites present on the probe would affect the sensitivity of a SPR sensor. From the data shown, it can be seen that the wavelength shifts on Probes 1 & 2 are ˜12% of those obtained by Probes 3 & 4. Therefore, we can conclude that the density of recognition sites on the MIP grown from surface initiation is much more than that of bulk polymerization.

Thus, an apparatus and simple and rapid method for the detection of PMP by SPR has been developed. This method shows that molecularly imprinted polymers grown by surface initiation on SPR sensors can increase the sensitivity of the sensor by several folds. Moreover, by using the signal transduced from the lanthanide test bed on the MIP, increasing the selectivity of the SPR sensor may be accomplished.

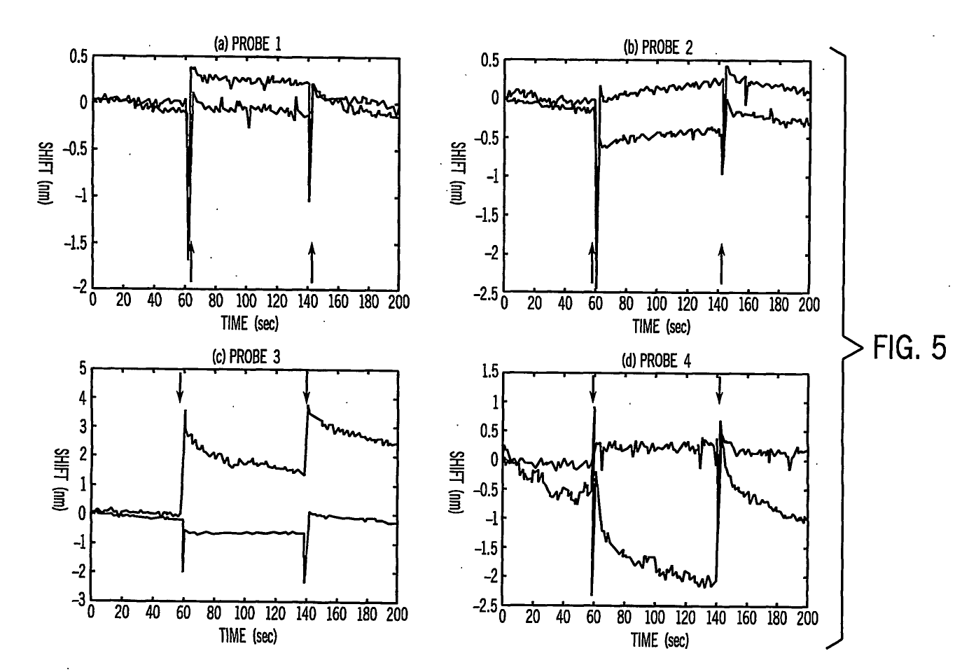

Turning to FIG. 6, a simplified, schematic embodiment of the invention featuring a sensor device 10 that includes an entrant medium 12 (e.g., optically pure silica fiber), and a metal (or semiconductor) film layer 14 with suitable optical parameters and thickness (e.g., gold or silver between 25-85 nm in thickness) and in which surface plasmons can be generated by light is shown. The metal layer 14 may be deposited directly on the entrant medium 12 as described above.

A monolayer of polymers 16 is disposed upon metal layer 14 to provide a sensing element. As is known to those skilled in the art, sulfur-bearing compounds can easily modify metal surfaces (including noble metal surfaces). Long-chain thiols, such as HS(CH₂)ₙX with n>10, adsorb from solution onto noble metals and form densely packed oriented monolayers (see, in general, S. Heyse et al. Biochimica et Biophysica Acta 85507 (1998) 319-338). The terminal group, X, of the thiol can be chosen from a wide variety of functional groups to interact with target molecules. Hence, for example, methacrylic acid (MAA), ethyleneglycol dimethacrylate (EDMA), styrene, and divinylbenzene (DVB) groups may be used as sensing elements as described above.

Associated with polymers 16 are fluorescent molecules 18, such as Europium or others selected from the lanthanide group of the periodic table of elements. After the sensor 10 has undergone molecular imprinting, target molecules 20 may by “captured” by cavities 22 as indicated by arrows 24, thereby interacting with the electrons of the fluorescent molecules 18 and with the plasmons of the metal layer 14. This interaction with the dual sensing motifs (i.e., SPR and fluorescence) produces two “spectral signatures” for a given target molecule that can be used to more reliably detect that molecule in solution and/or optimize the sensitivity and selectivity of a sensor.

Various changes in the details and components that have been described may be made by those skilled in the art within the principles and scope of the invention herein described in the specification and defined in the appended claims. Therefore, while the present invention has been shown and described herein in what is believed to be the most practical and preferred embodiments, it is recognized that departures can be made therefrom within the scope of the invention, which is not to be limited to the details disclosed herein but is to be accorded the full scope of the claims so as to embrace any and all equivalent processes and devices.

What is claimed is:

1. A dual-sensing motif chemical sensor for detecting a toxic nerve agent, comprising:
an entrant medium and thin film suitable for surface plasmon resonance,
a sensing element disposed upon said thin film; and
a fluorescent molecule associated with said sensing element.

2. The sensor of claim 1, wherein said sensing element comprises a polymer.

3. The sensor of claim 1, wherein said thin film comprises a metal or semiconductor layer disposed between said entrant medium and said sensing element.

4. The sensor of claim 1, wherein said fluorescent molecule is cross-linked to said sensing element.

5. The sensor of claim 1, wherein said fluorescent molecule comprises a lanthanide signal transducer.

6. The sensor of claim 2, wherein said polymer is selected from the group consisting of methacrylic acid, ethyleneglycol dimethacrylate, styrene, and divinylbenzene.

7. The sensor of claim 5, wherein said lanthanide signal transducer is cross-linked to a polymer of said sensing element.

8. The sensor of claim 7, wherein said lanthanide signal transducer comprises [Europium(vinylbenzoate)_{N}].

9. A spectroscopy system, comprising:
(a) a surface plasmon resonance spectroscopy apparatus;
(b) a sensor including an entrant medium in optical contact with a thin film layer; and
(c) a sensing element disposed upon said thin film layer for binding a target molecule, wherein the sensing element includes a fluorescent molecule.

10. The system of claim 9, wherein said sensing element comprises a polymer.

11. The system of claim 9, wherein said thin film comprises a metal or semiconductor layer disposed between said entrant medium and said sensing element.

12. The system of claim 9, wherein said fluorescent molecule is cross-linked to said sensing element.

13. The system of claim 9, wherein said fluorescent molecule comprises a lanthanide signal transducer.

14. The system of claim 10, wherein said polymer is selected from the group consisting of methacrylic acid, ethyleneglycol dimethacrylate, styrene, and divinylbenzene.

15. The system of claim 13, wherein said lanthanide signal transducer is cross-linked to a polymer of said sensing element.

16. The system of claim 15, wherein said lanthanide signal transducer comprises [Europium(vinylbenzoate)_{N}].

17. In a SPR spectroscopy system including an entrant medium with a thin film layer, the improvement comprising:
a sensing element for binding a target molecule to a surface of said thin film layer in combination with a fluorescent molecule.

18. The system of claim 17, wherein said sensing element comprises a polymer.

19. The system of claim 17, wherein said thin film comprises a metal or semiconductor layer disposed between said entrant medium and said sensing element.

20. The system of claim 17, wherein said fluorescent molecule is cross-linked to said sensing element.

21. The system of claim 17, wherein said fluorescent molecule comprises a lanthanide signal transducer.

22. The system of claim 18, wherein said polymer is selected from the group consisting of methacrylic acid, ethyleneglycol dimethacrylate, styrene, and divinylbenzene.

23. The system of claim 21, wherein said lanthanide signal transducer is cross-linked to a polymer of said sensing element.

24. The system of claim 23, wherein said lanthanide signal transducer comprises [Europium(vinylbenzoate)_{N}].

25. A method for detecting a target molecule present on a sensor, comprising the following steps:
(a) exposing a sensor including an entrant medium, a thin film suitable for surface plasmon resonance, a sensing element disposed upon said thin film, and a fluorescent molecule associated with said sensing element, to a solution putatively containing said target molecule; and
(b) performing spectroscopic measurements.

26. The method of claim 25, wherein said target molecule comprises a nerve agent.

27. The method of claim 26, wherein said nerve agent is Soman or a chemical simulant.

28. The method of claim 25, wherein said thin film is a metal.

29. A method for making a sensor used in a surface plasmon spectroscopic device, comprising the following steps:
(a) coating an entrant medium having a thin film suitable for surface plasmon resonance with a sensing element;
(b) associating a fluorescent molecule with said sensing element; and
(c) sensitizing said sensing element to a target molecule.

30. The method of claim 29, wherein step (c) comprises molecular imprinting.

31. The method of claim 29, wherein step (a) comprises surface-initiated polymerization.

32. The method of claim 29, wherein said sensing element comprises a polymer.

33. The method of claim 29, wherein said thin film comprises a metal or semiconductor layer disposed between said entrant medium and said sensing element.

34. The method of claim 29, wherein said fluorescent molecule is cross-linked to said sensing element.

35. The method of claim 29, wherein said fluorescent molecule comprises a lanthanide signal transducer.

36. The method of claim 32, wherein said polymer is selected from the group consisting of methacrylic acid, ethyleneglycol dimethacrylate, styrene, and divinylbenzene.

37. The method of claim 35, wherein said lanthanide signal transducer is cross-linked to a polymer of said sensing element.

38. The method of claim 37, wherein said lanthanide signal transducer comprises [Europium(vinylbenzoate)_{N}].

39. A chemical sensor featuring dual sensing motifs, comprising:
a first sensing motif suitable for surface plasmon resonance; and
a second sensing motif suitable for fluorescence.
